(19) United States
(12) Patent Application Publication
(10) Pub. No.: US 2026/0135617 A1
(43) Pub. Date: May 14, 2026

(54) OPTICAL PATH MONITORING APPARATUS AND PROCESS

(71) Applicant: The University of Queensland, St. Lucia (AU)

(72) Inventors: Andrew White, St. Lucia (AU); Michael David Harvey, St. Lucia (AU); Marcelo Pereira De Almeida, St. Lucia (AU); Till Joscha Weinhold, St. Lucia (AU)

(21) Appl. No.: 19/118,491

(22) PCT Filed: Oct. 5, 2023
(86) PCT No.: PCT/AU23/50965

§ 371 Date: Apr. 4, 2025

(30) Foreign Application Priority Data
Oct. 5, 2022 (AU) 2022902896

(51) Int. Cl. H04B 10/079; H04B 10/40

(52) U.S. Cl. CPC H04B 10/0795; H04B 10/40

(57) ABSTRACT

An optical path monitoring process, including the following steps executed by a first node of an optical network: (i) generating photons that are at least partially indistinguishable in frequency, polarization, spatial mode and temporal profile; (ii) transmitting a first photon of the generated photons to a remote node of the optical network over an optical path; (iii) receiving the first photon from the remote node over an optical path; and (iv) interfering the received first photon with a second photon of the generated photons to generate a quantum interference visibility output; and (v) assessing physical integrity of the optical path(s) on the basis of the quantum interference visibility output.

### TECHNICAL FIELD

The present invention relates to secure (e.g., encrypted) communications, and in particular to an optical path monitoring apparatus and process for assessing physical integrity of an optical path.

### BACKGROUND

Secure communications are essential in many situations. For example, in a military context, secured and protected communication amongst allies is paramount to freedom of action against an adversary. As is well known, the outcome of WWII was significantly influenced in both major theatres by the breaking of encryption codes. The breaking of German Enigma codes by Allied intelligence turned the tide of the Atlantic U-Boat war, and partially breaking the JN-25b code gave American forces a decisive edge in the Battle of Midway.

Modern communication encryption is based on mathematical algorithms with a trap-door function—an operation where the outcome is easily computed, but the inverse operation requires exponentially increasing computational resources, and is therefore generally considered to be computationally infeasible. Factorisation is one such trap-door operation, and lies at the heart of the “RSA” code developed by Rivest, Shamir and Adleman, probably the most famous encryption algorithm currently used to secure information. Such codes are used to encrypt communication traffic across the world wide web, to secure credit card transactions when shopping online, and to protect locally stored information on shared systems. Early uses of these codes were compromised by short cryptographic key lengths (40 bits) and poor random seed hygiene: in 1995, two PhD students at Berkeley showed that the then standard encryption in the Netscape web browser could be rendered useless with a clever malicious agent that could check the list of possible random seeds in minutes. This, and other demonstrations, overcame export-control limitations, and brought us to today's 128-bit standard, which is generally considered uncrackable by non-state actors.

In 1995, quantum mechanics was a small cloud on the horizon of internet security; by 2015 it had turned into a major scientific and technological storm that caused the US National Security Agency (NSA) to begin a transition to a “post-quantum” (i.e., secure against quantum attacks) era. In 1994, Peter Shor introduced an algorithm for a hypothetical quantum machine that operated with quantum bits—“qubits”—that could find co-prime numbers efficiently. In principle, the security of the RSA algorithm and every encryption code utilising factorisation as its security token became vulnerable overnight.

In practice however, such a quantum machine is still far away from reality as a capability today, but Shor's algorithm triggered a decades long effort to build such a quantum machine—a quantum computer—that could break encryption in a timely fashion. Initially driven mostly by academic research groups, the progress and potential of quantum computation prompted industry giants such as IBM, Google, and Microsoft to join the list of global players developing quantum computation technology, alongside dedicated startups such as PsiQuantum, Xanadu, and Rigetti.

In view of these developments, in 2015 the NSA recommended that: “For those partners and vendors that have not yet made the transition to Suite B elliptic curve algorithms, we recommend not making a significant expenditure to do so at this point, but instead to prepare for the upcoming quantum resistant algorithm transition.” (Suite B elliptic cryptographic algorithms are used to protect foreign-releasable information, US-Only information, and Sensitive Compartmented Information). Two practical obstacles to taking this advice are that: 1) as of late 2020 these codes are still not ready (NIST is conducting a years-long, multi-round selection process); and 2) quantum-resistant codes require significantly more computational time, and hence energy, than existing RSA codes, and hence are slower and more expensive to implement. Recognising this, in 2019 the NSA bought a window of time by replacing Suite B with the Commercial National Security Algorithm Suite (CNSA), which uses the same techniques with longer keys.

Another, although significantly less-favoured, post-quantum alternative is referred to as “Quantum Key Distribution” (or “QKD”), which creates and distributes a one-time key based on the randomness of quantum measurement, enabling users to create asymptotically secure communication channels. While QKD is an emerging commercial product, its implementation is hampered by a number of significant limitations that make it difficult to integrate into existing networks. These include, but are not limited to: limited range (≤100 km); only point-to-point communication; the requirement for a dedicated system for each communication channel and at each site, and markedly low data rates compared to current classical communications. These limiting factors explain the slow uptake of QKD globally, its low regard by the UK's Government Communications Headquarters (GCHQ) and the NSA, and it being limited to a few, admittedly high-profile, test-bed scenarios.

It is desired to overcome or alleviate one or more difficulties of the prior art, or to at least provide a useful alternative.

### SUMMARY

In accordance with some embodiments of the present invention there is provided an optical path monitoring process, including the following steps executed by a first node of an optical network:
(i) generating photons that are at least partially indistinguishable in frequency, polarization, spatial mode and temporal profile;
(ii) transmitting a first photon of the generated photons to a remote node of the optical network over an optical path;
(iii) receiving the first photon from the remote node over an optical path; and
(iv) interfering the received first photon with a second photon of the generated photons to generate a quantum interference visibility output; and
(v) assessing physical integrity of the optical path(s) on the basis of the quantum interference visibility output.

In some embodiments, the process includes repeating steps (i) to (v) to provide continuous monitoring of the physical integrity of the optical path(s).

In some embodiments, the first photon is transmitted and returned over the same optical path. In some embodiments, the first photon is transmitted and returned over different optical paths.

In some embodiments, the process includes storing the second photon for a duration corresponding to a time delay between transmitting the first photon to the remote node and receiving the first photon from the remote node.

In some embodiments, the process includes generating the first and second photons at different times corresponding to a time delay between transmitting the first photon to the remote node and receiving the first photon from the remote node.

In some embodiments, the process includes, prior to said step (iv) of interfering:
transmitting the second photon of the generated photons to a third node of the optical network over a further optical path; and
receiving the second photon from the third node over the further optical path or a yet further optical path;
wherein said assessing of the physical integrity of the optical path(s) on the basis of the quantum interference visibility output includes simultaneously assessing physical integrity of the further optical path(s).

In some embodiments, the process includes the following steps executed by the remote node:
receiving the first phonton from the first node; and
transmitting the first photon to the first node such that the indistinguishability in each of frequency, polarization, spatial mode and temporal profile of the first photon and the second photon is not entirely lost.

In some embodiments, the process further includes a step of multiplexing the first photon of the generated photons with an optical communications signal, wherein the first photon and the optical communications signal are distinguishable in at least one of frequency, polarization, spatial mode and temporal profile; and wherein the step of transmitting the first photon includes transmitting the multiplexed first photon and optical communications signal to the remote node over the optical path.

In some embodiments, the process further includes preventing subsequent communication with the remote node over the optical path(s) unless the physical integrity of the optical path(s) is assessed to be uncompromised.

In some embodiments, the process further includes the following steps executed by the remote node:
receiving the multiplexed first photon and optical communications signal;
separating the first photon from the optical communications signal; and
transmitting the first photon to the first node such that the indistinguishability in each of frequency, polarization, spatial mode and temporal profile of the first photon and the second photon is not entirely lost.

In accordance with some embodiments of the present invention there is provided an optical path monitoring apparatus having components configured to execute any one of the above processes.

In accordance with some embodiments of the present invention there is provided an optical path monitoring apparatus, including a first node including:
a quantum photon source configured to generate photons indistinguishable in frequency, polarization, spatial mode and temporal profile;
one or more optical components configured to transmit a first photon of the generated photons to a remote node of an optical network over an optical path, and to receive the first photon from the remote node over an optical path;
a quantum interference component configured to interfere the first photon received from the remote node with a second photon of the generated photons to generate a quantum interference visibility output; and
a path integrity component configured to assess physical integrity of the optical path(s) on the basis of the quantum interference visibility output.

In some embodiments, the apparatus is configured to provide continuous monitoring of the physical integrity of the optical path(s).

In some embodiments, the first photon is transmitted and returned over the same optical path. In some embodiments, the first photon is transmitted and returned over different optical paths.

In some embodiments, at least one of the optical paths includes a corresponding optical fibre path or waveguide. In some embodiments, at least one of the optical paths is a corresponding free space optical path.

In some embodiments, the one or more optical components includes a multiplexer component configured to multiplex a first photon of the generated photons with an optical communications signal, wherein the first photon and the optical communications signal are distinguishable in at least one of frequency, polarization, spatial mode and temporal profile, wherein the first photon is transmitted to the remote node multiplexed with the optical communications signal.

In some embodiments, the path integrity component is configured to prevent subsequent communication with the remote node over the optical path(s) if the physical integrity of the optical path(s) is assessed to be compromised.

In some embodiments, the apparatus includes a second node remote from the first node, the second node including optical components configured to receive the first photon from the first node, and to return the first photon to the first node such that the indistinguishability in each of frequency, polarization, spatial mode and temporal profile of the first photon and the second photon is not entirely lost.

In some embodiments, the apparatus includes means for storing the second photon for a duration corresponding to a time delay between transmitting the first photon to the remote node and receiving the first photon from the remote node.

In some embodiments, the quantum photon source is configured to generate the first and second photons at different times corresponding to a time delay between transmitting the first photon to the remote node and receiving the first photon from the remote node.

In some embodiments, the one or more optical components are configured to transmit the second photon of the generated photons to a third node of the optical network over a further optical path, and to receive the second photon from the third node over the further optical path or a yet further optical path; whereby the path integrity component assesses physical integrity of the optical path(s) and the further optical path(s) on the basis of the quantum interference visibility output.

### BRIEF DESCRIPTION OF THE DRAWINGS

Some embodiments of the present invention are hereinafter described, by way of example only, with reference to the accompanying drawings, wherein:

FIG. 1 is a high level block diagram of an apparatus for secure communications in accordance with some embodiments of the present invention;

FIG. 2 is a flow diagram of a process for secure communications in accordance with some embodiments of the present invention;

FIG. 3 is a block diagram of an apparatus for secure communications in accordance with some embodiments of the present invention;

FIG. 4 is a schematic diagram illustrating an apparatus for probabilistic photon number resolving detection in accordance with some embodiments of the present invention;

FIG. 5 is a block diagram of an apparatus for secure communication with multiple field nodes by temporal switching of photons between respective communications channels;

FIG. 6 is a block diagram of an apparatus for secure communication with multiple field nodes by simultaneous and parallel transmission of photons along respective communications channels;

FIG. 7 is a schematic block diagram of an apparatus for secure communication with multiple field nodes using a single quantum interference device; and

FIG. 8 is a schematic block diagram of a communications network incorporating multiple instances of an apparatus for secure communications in accordance with embodiments of the present invention.

### DETAILED DESCRIPTION

Embodiments of the present invention constitute a robust solution to the problem of physically securing communication links, thereby allowing the continued use of mature classical communication technology with its speed and network advantages. Existing physical layer security typically relies upon access limitations at user terminals—e.g., through the use of swipe cards or two-factor authentication—that verify the user as a trusted identity before granting access to the information in the system. However, this does not protect the link over which the communication is transmitted, and hence the information remains vulnerable to being intercepted if an adversary has access to the network infrastructure. Embodiments of the present invention address this shortcoming by overlaying a quantum signal in a channel of a classical telecommunication system, and performing a near-continuous integrity verification of the network, also referred to herein for convenience as “Quantum Link Verification” (“QLV”).

The advantages of the Quantum Link Verification described herein over QKD include that it can be used with existing communication networks, is not restricted to point-to-point architectures, and secures communications at current data rates. QLV exploits the fact that quantum light-particles of light, photons-behaves very differently to light at classical intensities. In particular, QLV makes use of two quantum phenomena:
(i) “no cloning”: this ensures that it is impossible to copy a quantum state—such as a single photon—without destroying the state and the information it carries. Thus it is impossible for an adversary to intercept and replicate the quantum state. This is used in key distribution to ensure the integrity of individual bits, whereas QLV uses it to ensure the integrity of an optical communication link; and (ii) “quantum interference”: two indistinguishable single particles of light that meet at a 50% beam splitter do not follow the classically-expected and equal probability of being transmitted or reflected on the beam splitter. Instead, the photons coalesce and leave the beam splitter as pairs. This effect, known in the art as Hong-Ou-Mandel (“HOM”) interference, is used in quantum photonics to measure the indistinguishability of photons, since the probability of the photonic coalescence diminishes as the two interfering photons become less alike. Perfect interference is signified by a zero rate of coincident photon measurements after the beam splitter: as the interference degrades, this rate increases.

Accordingly, embodiments of the present invention include an optical path monitoring process and apparatus that are able to assess physical integrity of an optical path (i.e., link) between nodes of an optical network, and whether that path may have been compromised. In this specification, the phrase “physical integrity” is to be understood as referring to integrity at the level of the physical layer of an optical network, where the term “integrity” does not require or imply any physical disruption or destruction of the physical communications medium itself (e.g., by cutting or breaking an optical fibre, which is generally trivial to detect), but rather whether the integrity of the optical path has been compromised; for example, by eavesdropping or any form of tampering that changes the optical transmission properties of the optical path. The monitoring involves generating photons that are at least partially indistinguishable in frequency, polarization, spatial mode and temporal profile. Each of these properties has a range of possible values, and consequently for any two photons it is possible for these values to overlap in some of the above properties but not others. The phrase “partially distinguishable” (or equivalently “partially indistinguishable”) refers to such a situation where photons are indistinguishable for some measurements, but distinguishable for others. Thus photons that are “at least partially indistinguishable” in frequency, polarization, spatial mode and temporal profile are indistinguishable by measurement of at least one of these properties.

One of these at least partially indistinguishable photons (referred to herein for convenience of reference as the “first” photon) is sent by a first node to a second, remote node over an optical path, and is returned by the remote node over the same or a different optical path to be received by the first node. The first node then interferes the first photon with another (“second”) of the at least partially indistinguishable photons to generate an output referred to herein as a “quantum interference visibility” output, which is indicative of the physical integrity of the optical path(s).

In the described embodiments, the first and second photons are generated simultaneously, and the second photon is (typically, but not necessarily, as described below) stored at the first node during the period in which the first photon is transmitted to and received from the remote node. However, in some alternative embodiments, the first and second photons are generated at different times corresponding to the time delay between transmitting the first photon to the remote node and receiving the first photon from the remote node. Clearly, such embodiments require a photon source capable of generating a pair of indistinguishable photons at respective different times. An example of a suitable photon source is described in Scalable performance in solid-state single-photon sources, J. C. Loredo, et al. Optica 3, 433, 2016 (“Loredo”).

As will be appreciated by those skilled in the art, there are different ways to store the second photon in a manner that preserves the ability to use Hong-Ou-Mandel interference with the first photon. The most straightforward way to achieve this is to send the second photon through an optical fibre delay line. Examples of this are described in Loredo, and in Hectometer Revivals of Quantum Interference, M. Rambach et. al., Physical Review Letters 121, 093603 (2018).

One alternative is to use a cavity loop, an example of which is described in Time-multiplexed heralded single-photon source, F. Kaneda et al. Optica 2, 1010 (2015). This involves sending the second photon to a cavity formed by highly-reflective mirrors and an electro-optical switch. While in the cavity, the second photon makes multiple round trips between the mirrors. When the total number of round trips corresponds to the total distance travelled by the first photon (allowing for passage of the second photon to and from the cavity), the electro-optical switch is then controlled to release the second photon so that it can be interfered with the first photon.

Another alternative is to temporarily store the second photon in a quantum memory and then release it so that it can be interfered with the first photon. Details of single-photon storage in quantum memories are described in Quantum memories for fundamental science in space, Jean Michael Mo et al., Quantum Science and Technology, 8, 024006 (2023).

Embodiments of the present invention also include secure communications apparatuses and processes wherein the optical path monitoring is combined with optical communications to assess whether those communications may be compromised; for example, by eavesdropping. Thus in some embodiments, the first photon is multiplexed with a communications signal, and the resulting multiplexed signal is transmitted to the remote node. The remote node separates the first photon from the communications signal, and returns the separated first photon to the first node so that the integrity of the communication can be assessed. Unless the first node assessed the communication to be uncompromised, it can prevent further communication with the remote node. In some embodiments, the (un-multiplexed) first photon is sent to the remote node prior to any such communication signal, so that the latter is only sent to the remote node after the optical link(s) is or are assessed as being uncompromised.

Suitable methods for multiplexing the first photon with a communications signal include standard methods that are well-known to those skilled in the art, and either or both of the second photon and the communication signal can be coupled on and/or off the optical link(s). By way of example, some of the most well-known standard methods include:
(i) wavelength division multiplexing wherein the first photon has a slightly different wavelength to that or those of the communications channel signal(s);
(ii) time-division multiplexing wherein the second photon and the communications signal are sent in different time-slices (for example, the second photon can be coupled on or off the channel when the communication signal is not present, either because it has been briefly interrupted to allow for the coupling or opportunistically when there is a lull in signal traffic on the channel, as described in Towards high-capacity quantum communications by combining wavelength and time-division multiplexing technologies, Wen-Tan Fang et al., Proc. SPIE 10771, Quantum Communications and Quantum Imaging XVI, 1077112(2018 );
(iii) mode division multiplexing wherein the second photon and the communication signal are coupled to different channel modes (e.g., spatial modes of a waveguide or propagating modes in free space), and an appropriate filter, mode converter, or other distinguishing element is used to selectively couple the second photon on or off the channel while allowing the communication signal to pass (as described in, for example, Mode multiplexed single-photon and classical channels in a few-mode fiber, J. Carpenter et al., Optics Express 23, 28794 (2013)); and
(iv) Spatial path multiplexing, wherein the second photon is coupled to a slightly different spatial path than the communication signal. For example, there may be a slight difference in the optical axis of the second photon relative to the communication signal (e.g., by spatial translation or angle), or the second photon may be coupled to a different part of a waveguide structure or a different waveguide in a multi-guide bundle.

These are merely some of the more salient multiplexing methods, and other suitable methods will be apparent to those skilled in the art in light of this disclosure.

In some embodiments, the apparatus and process use a pair of indistinguishable photons. One (‘first’) photon is retained in a delay loop at a trusted entry to the link, which is referred to herein as the home node, A, and thus this retained photon is also referred to herein for convenience as the “A photon”. The other (‘second’) photon is sent to a remote or “field” node, B, of the link, and is therefore also referred to as the “B photon”, where it is then reflected back to node A and interfered with the first or A photon. When the delay at node A is selected or tuned to match the link length, the coincident rate drops to zero: this being the output signal indicative of a fully secured link. Any attempt by an eavesdropper to intercept the link, either partially or in full, will lead—via the no-cloning quantum phenomenon—to the B photon becoming distinguishable from the A photon, which will lead—via quantum interference—to the coincidence rate becoming non-zero, indicative of the eavesdropping.

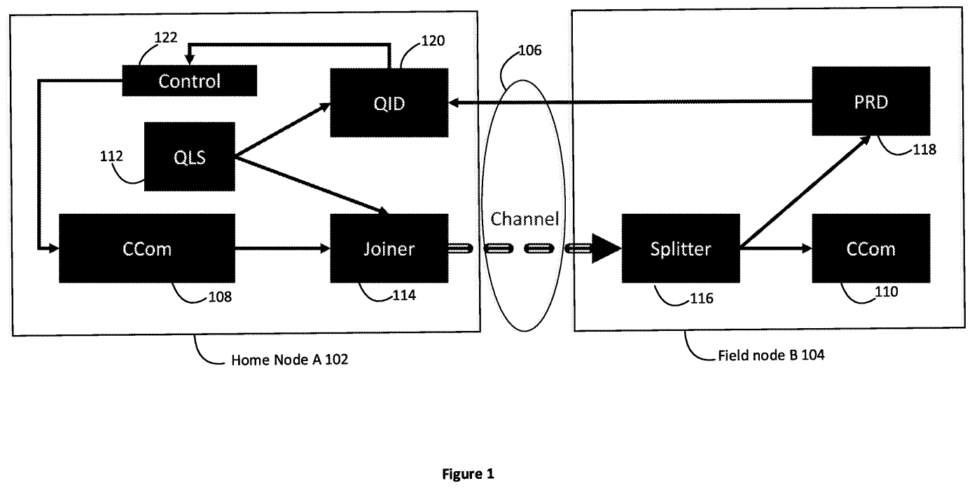

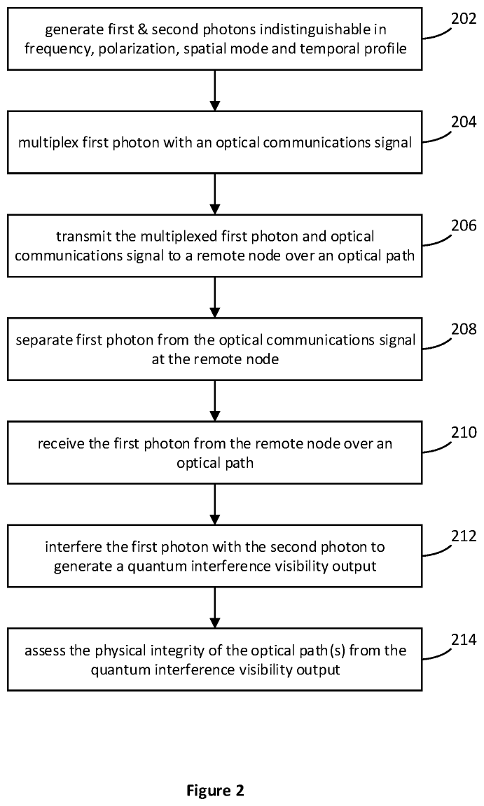

FIG. 1 is a high level block diagram of an apparatus for secure communications in accordance with some embodiments of the present invention, and FIG. 2 is a flow diagram of a process for secure communications in accordance with some embodiments of the present invention. As shown in FIG. 1, a first or ‘home’ node A 102 communicates with a remote or ‘field’ second node B 104 via at least one optical path (e.g., at least one optical fibre, waveguide, or free space path) 106, which is the physical path (or “link”) that is verified by Quantum Link Verification. The two nodes 102, 104 include optical transceivers and signal generators (shown for simplicity aggregated at the nodes 102, 104 as CCom 108 and CCom 110, respectively) for communication using classical communication protocols.

The home node A 102 includes a quantum light source (“QLS”) 112, being a non-classical source of photons that produces, at step 202 of the secure communications process, quantum states of light in at least two distinct optical modes. As an example for the described case of a pair of single photons, one in each of two optical modes, referred to herein as “home and “travel” photons, respectively. The home and travel photons must possess some de minimis amount of indistinguishability in each of the optical properties of: frequency, polarisation, spatial mode, and temporal profile, and are thus described herein as being at least partially indistinguishable in each of these properties.

The optical classical telecommunication signals (OCTS) generated by the CCom 108 of the home node A 102 and the “travel” photon are received by a “Joiner” component 114 that multiplexes, at step 204, one of the optical classical telecommunication signals (OCTS) with the travel photon. At step 206, these are then transmitted over the optical path or link 106. The OCTS and the travel photon must be distinguishable in at least one of the same four properties mentioned above, namely: frequency, polarisation, spatial mode, and temporal profile. For example, in various embodiments, the OCTS and the travel photon have orthogonal polarisations and/or non-overlapping frequency modes. Any attempt to intercept or otherwise gain access to the classical communication signals will also affect the travel photon.

At the remote field node B 104, the optical signals are received by a splitter component 116 that spatially separates the travel photon from the OCTS at step 208. The OCTS are sent to the receiver CCom 110, and the travel photon is sent to a “Photon Return Device” (“PRD”) 118 that returns the travel photon back to the home node A 102, either over the same or a different optical path. The return transmission must be such that indistinguishability in the four properties mentioned above is not entirely lost. This can be verified by, for example, a Hong-Ou-Mandel interference measurement producing a non-zero non-classical interference result.

If the system has drifted outside of the range where non-classical interference can be observed, it is possible to recover this through either: (i) the use of compensation optics to undo the changes of the channel, or (ii) stabilisation and isolation of the channel from the environment. For example, if the drift is in polarisation (as determined by monitoring one of the classical communication channels, for example), then applying suitably correlated compensation to the quantum and monitoring channels to compensate the polarisation rotation of the classical monitoring signal will also return the quantum interference signal to its original level if no other change has occurred. Thus by monitoring, and where necessary, compensating all “normal” methods, the system can be maintained in, and/or returned to, the state where quantum interference will occur.

At step 210, the returning travel photon is received at the home node A 102 by a quantum interference device (“QID”) 120 that also receives the home photon so that the quantum interference visibility output can be generated at step 212. At step 214, the output of the QID 120 is received by a control component 122, which assesses the physical integrity of the optical path(s), and thus the security of the communication, and optionally prevents further communication if the Quantum Interference Visibility result is outside acceptable limits, indicating that the optical path has (or paths have) been compromised.

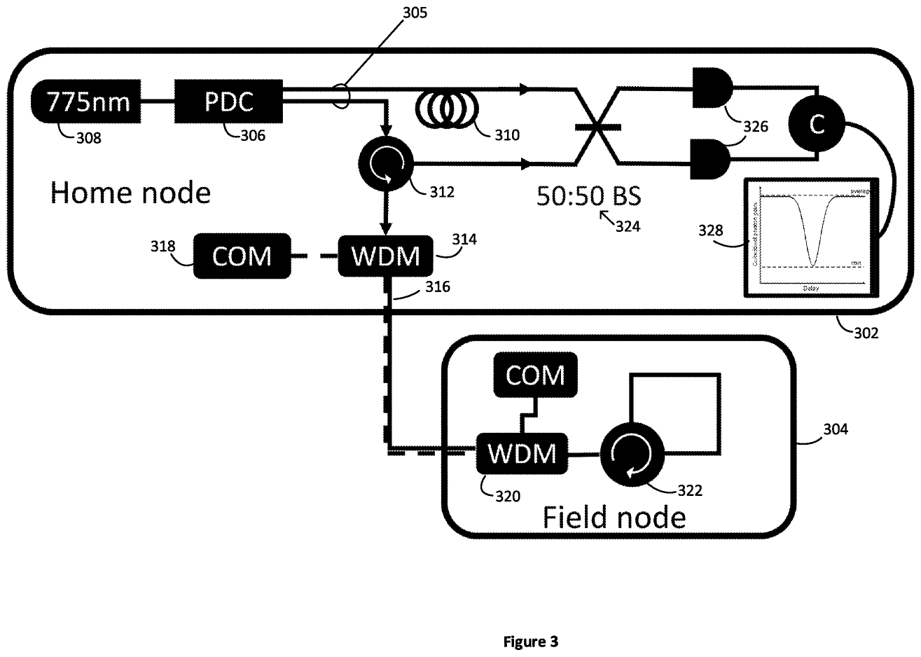

FIG. 3 is a schematic diagram illustrating an embodiment of an apparatus for secure communications using telecommunication fibre between a home node 302 and a remote field node 304. Photon pairs 305 are produced at 1550 nm by a commercially available photon down-conversion device (“PDC”) 306 (e.g., an optically non-linear crystal) pumped by a 775 nm laser 304. In the described embodiments, the photon down-conversion device 306 is a NuCrypt EPS-1000 photon source, as described at http://nucrypt.net/EPS-1000.html, but alternative down-conversion devices will be apparent to those skilled in the art.

One photon of each pair (the “first” or “home photon”) is kept at the trusted entry to the link, the home node 302, by being coupled into a variable delay line 310. The variable delay line 310 consists of both a fixed fibre delay and a tuneable free-space element to ensure path-length matching to within the coherence length of the photon (typically 10 s to 100 s of microns, depending on bandwidth). As the home photon is never transmitted, and never leaves the home node, it cannot be accessed by an adversary at any time.

The other photon of the pair (the “second” or “field photon”) is routed via an optical circulator 312 into a wavelength division multiplexer (“WDM”) 310, where it is overlaid into a single optical fibre 316 together with a classical communication signal generated by a signal generator (“COM”) 318. This fibre 316 connects the home node 302 to the field node 304. At the field node 304, a second WDM 320 splits the classical communication from the single photon signal. The separated single photon is then returned to the second WDM 320 by a further circulator 322, and is then sent back across the same optical fibre 316 to the home node 302. The WDM 314 and circulator 312 of the home node 302 separate the returned field photon and route it to a 50% beam splitter (“50:50 BS”) 324 to perform the quantum interference measurement with the delayed home photon. In the embodiment of FIG. 3, this measurement is achieved using a pair of single-photon detectors 326. Monitoring the single and coincidence count rates (“C”) 328 between the two single-photon detectors 326 allows detection of any physical interference with the optical fibre between the home and field nodes 302, 304.

It will be apparent that the home photon needs to be delayed by a time that corresponds to the effective round-trip time of the field photon so that both photons can mutually interfere. In practice, this is achieved by performing an initial measurement of the field photon delay period at a time when the optical path(s) are assessed to be secure (for example, by physically inspecting the entire length of the fibre(s) during commissioning of the apparatus), and then calibrating the home photon delay period by making it the same as the measured field photon delay period. Once the delay period has been measured and calibrated, any variation in the length(s) of the optical path(s) between the two nodes (and/or any change in the time spent by the field photon within the remote node) will cause a change in the effective round-trip time of the field photon, thereby preventing or at least inhibiting the mutual interference of the home and field photons.

QLV is wavelength agnostic, and can be equally employed in either optical fibre—which employs five wavelength bands between 1260 and 1625 nm—or free-space communication networks, which typically are at either near-infrared (780 nm) or infrared (1550 nm) wavelengths. As known by those skilled in the art, suitable photon sources are well-developed, and indeed commercially available, for these wavelength ranges.

Modern telecom communications utilise a large number of frequencies within each single optical path or link: in telecommunications each link is optical fibre, and the information is routed into and out of the fibre by wavelength division multiplexing (WDM). In free-space, the optical path/link is defined by bulk optics, and the same technique is used, although if the carrier is radio or 4G it is referred to as frequency-division multiplexing (FDM)—since the carrier is conventionally described by frequency—but the physical principle is identical.

C-band telecommunication over the wavelength range of 1530-1565 nm uses dense WDM (DWDM) to combine 80 frequency channels into a single optical fibre. More recently, ultra-dense WDM has achieved 320 channels, and moving to the L-band, 1565-1625 nm, will effectively double these capacities. In any such embodiments, the QLV signal only requires one of these channel frequencies, leaving the remainder for full capacity classical communications. In practice, one more channel is reserved for measuring the link length by optical time-domain reflectometry (or equivalent), providing the information required for tuning the variable delay in the home node. Thus the link can be continuously verified as secure at the cost of a small reduction in the achievable information capacity, from 2.5% (C-band, DWDM) to 0.3% (L-band, UDWDM).

The secure communications processes and apparatuses described herein are effective to detect the actions of adversarial eavesdroppers on optical communications between nodes of a communications network. For example, consider an eavesdropper, Eve, attempting to gain access to a communications link in each of the following three different attack scenarios.

### Attack 1: Signal-splitting

In this attack, Eve attempts to splice in a fibre beam-splitter with a low splitting ratio to siphon off a small amount of the classical signal field—which Eve processes on their own WDM to extract information—while passing the majority of the signal onwards to the field node. This type of attack can be detected as an increase in coincidences or a decrease in non-classical visibility, since the overall path length is altered by the presence of the fibre beam splitter. The change in coincidence and non-classical visibility can be correlated with the signal-splitting ratio.

### Attack 2: Channel-selective

In this attack scenario, Eve employs a WDM before her fibre beam splitter, attempting to evade detection by not routing the channel of the quantum signal to their siphon beam splitter. After siphoning off the classical communication signal, Eve recombines the signal with the quantum channel utilising a second WDM, and sends the rejoined signal to the field node. Such an attack is more challenging, but can be addressed by randomly switching the quantum signal to different WDM channels at the home node, which obviates Eve's evasion strategy, and detects Eve's presence by a diminished non-classical interference or increased coincidence as per Attack 1. The field node does not need to know which of the WDM channels provides the quantum signal, because it returns a fraction of the signals received on all WDM channels to the home node, which of course knows which of those channels provides the returned fraction of the quantum signal.

### Attack 3: Quantum Channel Blockade

The quantum channel blockade attack exploits the fact that naïvely successful link verification is indicated by a zero rate of coincidences in the quantum interference measurement. Eve's strategy is to exploit this by using a WDM and fibre beam splitter as in the channel selective attack described above, but now simply blocking the quantum channel transmission. As no second photons return, the rate of coincidences will still remain at the background level.

There are two ways to counter this attack. Firstly, the random switching used to defeat Attack 2 will also work here. Additionally or alternatively, both the single-photon rate and the coincident count rate can be monitored. By blocking the returning single photons, Eve reduces the amount of potentially detected single photons at the home node by half. After establishing the link, this will be a clear indication of eavesdropping.

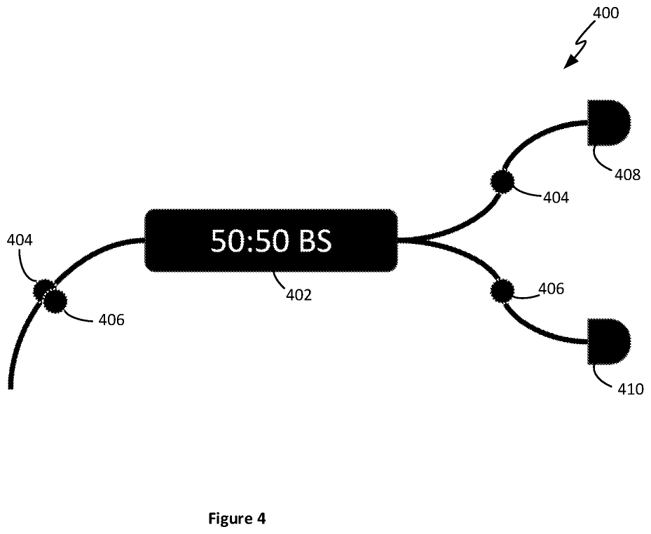

The secure communications processes and apparatuses can also detect if Eve established surreptitious hardware in the link before the initial calibration. In this case, the secure communications apparatus uses detectors that can distinguish between single photons and two-photons. If and when Eve blocks the quantum signal, the secure communications apparatus measures a marked reduction in the rate of two-photon events at each detector—since these arise from non-classical interference which Eve is eliminating—but will continue to see some rate of single-photon detections. In practice, probabilistic photon-number resolution can be robustly realised by a compound detector 400 consisting of a 50% beam-splitter 402 with single-photon detectors 408, 410 at respective outputs, as shown in FIG. 4. The fibre beam splitter 402 probabilistically divides the two incoming photons 404, 406 into different output modes, allowing the two non-photon number resolving detectors 408, 410 to correctly identify the presence of the two photons 404, 406. Two-photon events show up as coincidences between the two local detectors 408, 410 within the compound detector 400: when these cease, non-classical interference has been turned off, and eavesdropping has been detected.

### Quantum Verification of a Multi-node Telecommunication Network

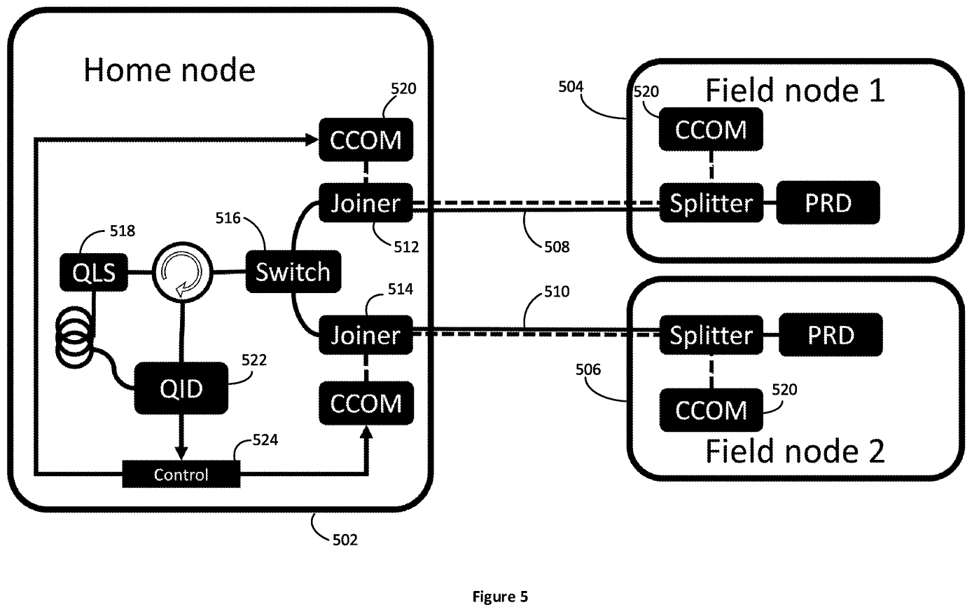

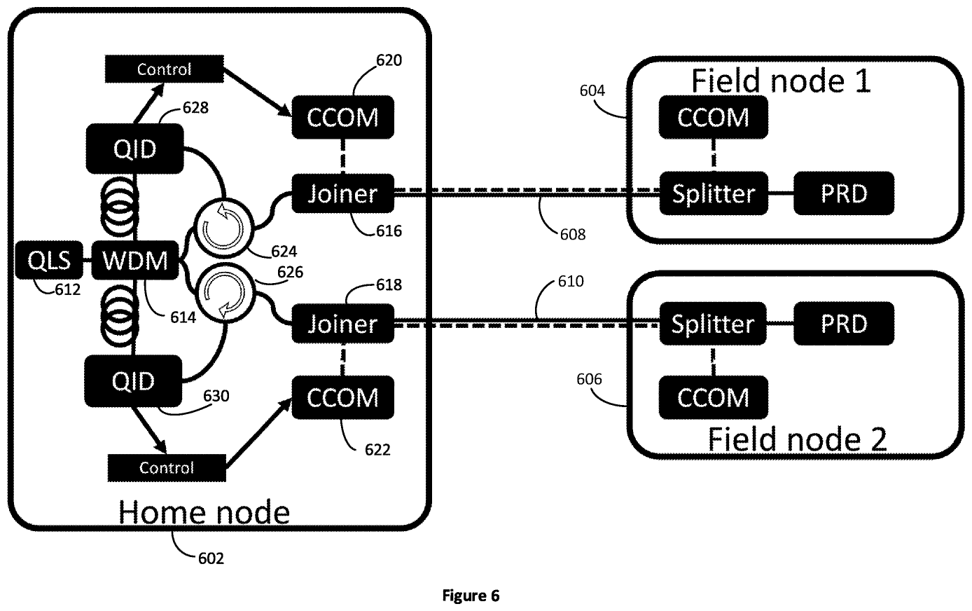

Real-world communication architectures are often not just point-to-point connections, with ring and star network architectures commonplace. FIGS. 5 and 6 are block diagrams of respective embodiments of secure communications apparatuses for use in multi-nodal communication networks, each shown with one trusted home node 502 (or 602) and (for the sake of simplicity, only) two untrusted field nodes 504, 506 (or 604, 606), the field nodes being communicatively coupled to the home node in a point-to-point manner by respective dedicated optical paths (e.g., fibres) 508, 510 (or 608, 610).

As shown in FIG. 5, in a random-switching quantum link embodiment, the home node 502 includes respective dedicated WDMs (or “Joiners”) 512, 514 for the optical paths 508, 510. A switch 516 dynamically and quasi-randomly selects one of the WDMs 512, 514 to receive the quantum signal generated by a quantum photon source (“QLS”) 518, and thus which of the links 508, 510 is being verified. Classical communication devices CCOM 520 encrypt and decrypt the communications signals, and a quantum interference device (“QID”) 522 uses a beam-splitter and detectors to perform the quantum interference measurement. In the embodiment of FIG. 5, a control component 524 is included to disable the CCOMs 520 of the home node 502 if the output of the QID 522 is indicative of eavesdropping to prevent further communication. Classical communication lines are shown as solid lines, while the paths of the quantum state are shown as dashed lines. The communication and quantum signals between the home node 502 and each of the field nodes 504, 506 travel together along the same optical fibre 508, 510.

In a further embodiment, as shown in FIG. 6, multi-band down-conversion quantum link verification is used to simultaneously verify multiple links to respective field nodes 604, 606 of a multi-node network. By utilising the breadth of down-converted signals in frequency, photons are generated within the home node 602 by a QLS 612 in multiple wavelength channels. A WDM 614 splits these into respective outputs and routes them to respective further WDMs (or “Joiners”) 616, 618 to overlay with classical communication signals generated by respective CCOMs 620, 622. The benefit of this configuration is that the links 608, 610 between the home node 602 and all field nodes 604, 606 are continuously verified, albeit at the cost of additional physical resources (specifically, a corresponding dedicated circulator 624, 626 and QID 628, 630 per link 608, 610) at the home node 602 to perform the verifications once the single photons have returned from the field nodes 604, 606 to the home node 602.

It will be apparent from the above that the advantage of random-switching (FIG. 5) over multi-band verification (FIG. 6) is that in the former the home node requires only one circulator and QID, regardless of which of the links 508, 510 is being verified. The disadvantage is that by temporally switching the verification actions across the different links 508, 510, the network as a whole is not being continuously monitored, unlike the point-to-point configuration (FIG. 6).

The advantage of multi-band down-conversion is that the entire network is continuously verified, but at the cost of requiring one additional WDM and additional circulators to route the different quantum signals to different field nodes, and additional quantum interference components—not only delay lines but also beam-splitters and detection analysis components—at the home node.

For more complicated network topologies or use-cases, different combinations of the two configurations can be used.

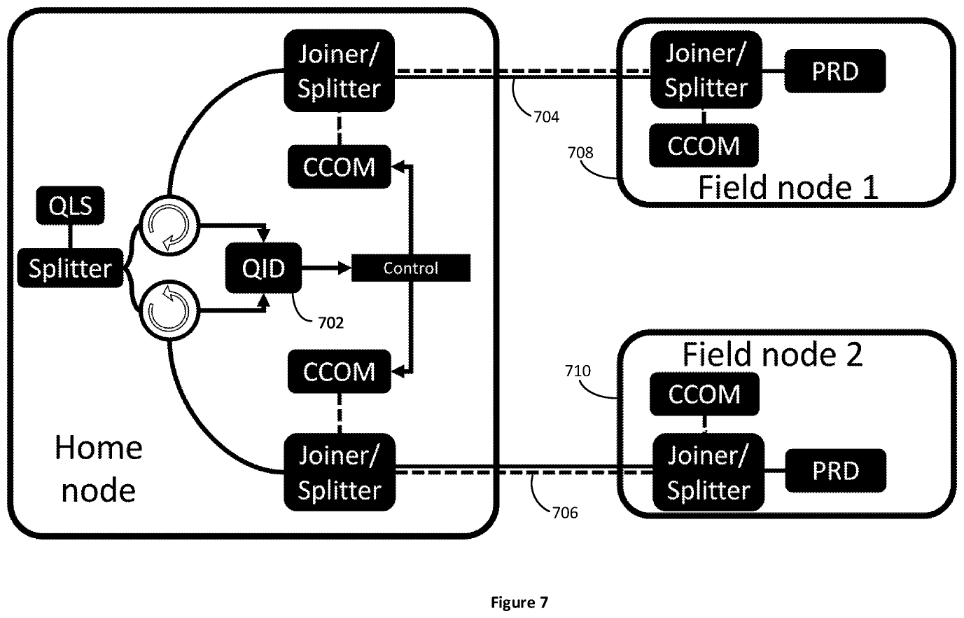

In an alternative embodiment, as shown in FIG. 7, a single quantum interference device QID 702 is used to simultaneously assess the physical integrity of the optical paths 704, 706 to multiple field nodes 708, 710. Whilst requiring fewer components than the configuration shown in FIG. 6, this configuration does not allow identification of which of the optical paths 704, 706 was (or were) disturbed by an eavesdropper.

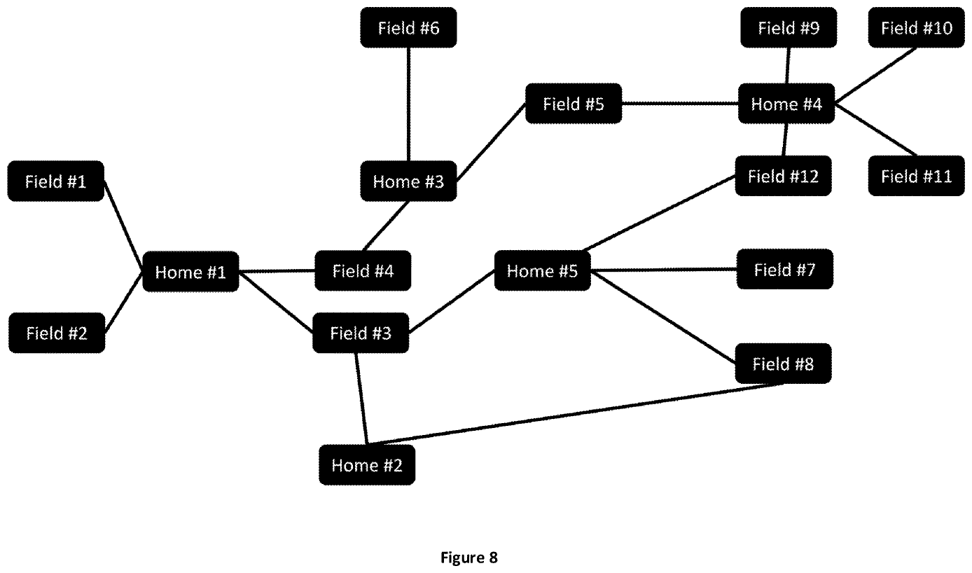

Quantum link verification has been described above for point-to-point communication links between a home node and multiple field nodes. However, if two home nodes are connected to the same field node, then a link across the network can be verified, either through independent verification of each sub-segment link, or bypassing one signal through multiple nodes. In this manner, large networks can be monitored and verified, as illustrated in FIG. 8.

Although some embodiments of the present invention have been described above in the context of optical fibre link verification, it will be apparent that the processes and apparatuses described herein may be readily adapted for verification of line of sight free space optical links, using free space transceivers to transmit and receive free space optical signals. Free-space optical links are a rapidly growing part of modern telecommunication infrastructure, being used: as the backhaul for both LTE and 5G networks; for connecting base stations; as “last-mile” connections in roll-outs complicated by geography, urban geometry, or political landscape; in airports; by the military sector; and for temporary wireless connection in disaster recovery, be it domestic or international.

A potential issue of particular relevance to free-space communications is where the first photon returns to the home node in an altered state due to environmental factors, rather than eavesdropping. However, it is expected that environmental factors can be distinguished from eavesdropping by monitoring their temporal occurrence determining correlations with environmental events such as changing weather conditions (e.g., humidity, pressure), Heating, Ventilation and Air Conditioning (HVAC) switching in a data centre, and the like.

For example, one or more of the following methods, and combinations thereof, can be used to distinguish between environmental effects and eavesdropping attacks.

The quantum interference signals can be monitored as a function of time and assessed using time series statistics to identify events and infer the time scales at which they occur, long-term events being indicative of an attacker. In some embodiments, a Fast-Fourier-Transform of the quantum interference signals is analysed to identify spectral changes. Similarly, an autocorrelation of the quantum interference signals can be used to distinguish between usual and unusual events.

Fluctuations in the communication signal can also be monitored and correlated with changes in the quantum interference signal to assess the likely cause of the latter.

A secondary probe signal can be introduced into the optical path to assess path losses and timing, and provide a calibration for the return rate of the first photon.

Machine learning can be applied to the quantum interference signals to infer characteristic patterns that distinguish between different causes of changes to the quantum interference signals.

Causal or non-causal filters can be used to allow later data to inform the reliability of earlier data. At high photon rates, this might only introduce a delay of a few milliseconds in the analysis. At the other extreme, the signal can be post-processed to identify likely past intrusion events.

A periodic self-calibration can be performed by sending the photon pair along the channel with different time delays to gather statistics on the random fluctuations. This is compared with the QLV signal to help reject false positives caused by these fluctuations.

An alert process can be used to filter the results of any or all of the above methods. For example, an alert threshold can be set by an operator so that an alert is only raised if the threshold is exceeded. The threshold level can be selected depending on the desired level of security, with higher security levels risking more false positives if no other steps are taken to distinguish the cause of changes to the quantum interference signal outputs.

The apparatus can include or be coupled with a component or system that monitors and compensates for environmental changes. For example, in free-space applications, adaptive optics elements can be used to compensate for optical distortions caused by the atmosphere, as described in Adaptive Optics for Astronomy, R. Davies, and M. Kasper, Annual Review of Astronomy and Astrophysics 50, 305 (2012).

In the case of an optical fibre link subjected to mechanical stress, changes to the photon properties can be compensated using active fibre polarisation controllers and dispersion This methodology was recently used to demonstrate the feasibility of protecting the properties of single photons propagating over distances of more than 1000 km in an optical fibre cable (Experimental Twin-Field Quantum Key Distribution over 1000 km Fiber Distance, Yang Liu et al., Physical Review Letters 130, 210801 (2023)).

Many modifications will be apparent to those skilled in the art without departing from the scope of the present invention.

1. An optical path monitoring process, including the following steps executed by a first node of an optical network:
(i) generating photons that are at least partially indistinguishable in frequency, polarization, spatial mode and temporal profile;
(ii) transmitting a first photon of the generated photons to a remote node of the optical network over an optical path;
(iii) receiving the first photon from the remote node over an optical path; and
(iv) interfering the received first photon with a second photon of the generated photons to generate a quantum interference visibility output; and
(v) assessing physical integrity of the optical path(s) on the basis of the quantum interference visibility output.

2. The process of claim 1, including repeating steps (i) to (v) to provide continuous monitoring of the physical integrity of the optical path(s).

3. (canceled)

4. (canceled)

5. The process of claim 1, including storing the second photon for a duration corresponding to a time delay between transmitting the first photon to the remote node and receiving the first photon from the remote node.

6. The process of claim 1, including generating the first and second photons at different times corresponding to a time delay between transmitting the first photon to the remote node and receiving the first photon from the remote node.

7. The process of claim 1, including, prior to said step (iv) of interfering:
transmitting the second photon of the generated photons to a third node of the optical network over a further optical path; and
receiving the second photon from the third node over the further optical path or a yet further optical path;
wherein said assessing of the physical integrity of the optical path(s) on the basis of the quantum interference visibility output includes simultaneously assessing physical integrity of the further optical path(s).

8. The process of claim 1, including the following steps executed by the remote node:
receiving the first photon from the first node; and
transmitting the first photon to the first node such that the indistinguishability in each of frequency, polarization, spatial mode and temporal profile of the first photon and the second photon is not entirely lost.

9. The process of claim 1, further including a step of multiplexing the first photon of the generated photons with an optical communications signal, wherein the first photon and the optical communications signal are distinguishable in at least one of frequency, polarization, spatial mode and temporal profile; and wherein the step of transmitting the first photon includes transmitting the multiplexed first photon and optical communications signal to the remote node over the optical path.

10. The process of claim 9, including preventing subsequent communication with the remote node over the optical path(s) unless the physical integrity of the optical path(s) is assessed to be uncompromised.

11. The process of claim including the following steps executed by the remote node:
receiving the multiplexed first photon and optical communications signal; separating the first photon from the optical communications signal; and
transmitting the first photon to the first node such that the indistinguishability in each of frequency, polarization, spatial mode and temporal profile of the first photon and the second photon is not entirely lost.

12. (canceled)

13. An optical path monitoring apparatus, including a first node including:
a quantum photon source configured to generate photons indistinguishable in frequency, polarization, spatial mode and temporal profile;
one or more optical components configured to transmit a first photon of the generated photons to a remote node of an optical network over an optical path, and to receive the first photon from the remote node over an optical path;
a quantum interference component configured to interfere the first photon received from the remote node with a second photon of the generated photons to generate a quantum interference visibility output; and
a path integrity component configured to assess physical integrity of the optical path(s) on the basis of the quantum interference visibility output.

14. The apparatus of claim 13, wherein the apparatus is configured to provide continuous monitoring of the physical integrity of the optical path(s).

15. (canceled)

16. (canceled)

17. The apparatus of claim 13, wherein at least one of the optical paths is a corresponding optical fibre path or waveguide.

18. The apparatus of claim 13, wherein at least one of the optical paths is a corresponding free space optical path.

19. The apparatus of claim 13, wherein the one or more optical components including a multiplexer component configured to multiplex a first photon of the generated photons with an optical communications signal, wherein the first photon and the optical communications signal are distinguishable in at least one of frequency, polarization, spatial mode and temporal profile, wherein the first photon is transmitted to the remote node multiplexed with the optical communications signal.

20. The apparatus of claim 19, wherein the path integrity component is configured to prevent subsequent communication with the remote node over the optical path(s) if the physical integrity of the optical path(s) is assessed to be compromised.

21. The apparatus of claim 13, including a second node remote from the first node, the second node including optical components configured to receive the first photon from the first node, and to return the first photon to the first node such that the indistinguishability in each of frequency, polarization, spatial mode and temporal profile of the first photon and the second photon is not entirely lost.

22. The apparatus of claim 13, including means for storing the second photon for a duration corresponding to a time delay between transmitting the first photon to the remote node and receiving the first photon from the remote node.

23. The apparatus of claim 13, wherein the quantum photon source is configured to generate the first and second photons at different times corresponding to a time delay between transmitting the first photon to the remote node and receiving the first photon from the remote node.

24. The apparatus of claim 13, wherein the one or more optical components are configured to transmit the second photon of the generated photons to a third node of the optical network over a further optical path, and to receive the second photon from the third node over the further optical path or a yet further optical path; whereby the path integrity component assesses physical integrity of the optical path(s) and the further optical path(s) on the basis of the quantum interference visibility output.
